(19) United States
(12) Patent Application Publication
(10) Pub. No.: US 2004/0114368 A1
(43) Pub. Date: Jun. 17, 2004

(54) Light device having rotatable or movable view

(76) Inventor: Shing Jy Shyu, Taipei Hsien (TW)

Correspondence Address: Shing Jy Shyu, P.O. Box 10-69, Chong Ho, Taipei, 235, TW

(21) Appl. No.: 10/320,133

(22) Filed: Dec. 13, 2002

(51) Int. Cl. F21V 1/10

(52) U.S. Cl. 362/280; 362/284; 362/323

(57) ABSTRACT

A light device includes a casing rotatably supported on a base and received in a stationary housing. A light member is received in the casing for generating light through the casing and the housing. A motor may be coupled to the casing with a gear and a pinion, for rotating the casing relative to the housing. The housing and the casing include patterns to be moved relative to each other when the casing is rotated relative to the housing by the motor. A cover may be secured on the housing and includes a circular passage for rotatably receiving top of the casing.

### BACKGROUND OF THE INVENTION

1. Field of the Invention

The present invention relates to a light device, and more particularly to a light device having a rotatable or movable view or image.

2. Description of the Prior Art

Typical light devices comprise a lamp shade disposed above or on the outer portion of a light member. The lamp shades of the typical light devices normally may not be rotated or moved.

The present invention has arisen to mitigate and/or obviate the afore-described disadvantages of the conventional light devices.

### SUMMARY OF THE INVENTION

The primary objective of the present invention is to provide a light device including a rotatable or movable casing having a painting or pattern provided thereon for forming or providing a rotatable or movable view or image.

In accordance with one aspect of the invention, there is provided a light device comprising a base, a casing rotatably supported on the base, a housing disposed on the base and having the casing rotatably received in the housing, a light member received in the casing, for generating light through the casing and the housing, and a rotating device for rotating the casing relative to the housing. The housing and the casing are made of transparent or semi-transparent materials, for allowing the light generated by the light member to emit through the housing and the casing.

The housing includes a pattern provided thereon, the casing includes a pattern provided thereon and movable relative to the pattern of the housing when the casing is rotated relative to the housing.

The rotating device includes a motor attached to the base and having a spindle, a pinion attached to the spindle of the motor, and a gear attached to the casing and engaged with the pinion, for allowing the casing to be rotated by the motor via the gear and the pinion.

The base includes a receptacle having a hub provided thereon, the gear includes an aperture formed therein for rotatably receiving the hub of the receptacle. The rotating device further includes a transformer secured in the base and electrically coupled to the motor. The light member may be engaged through the hub and received in the casing.

A cover may further be provided and secured on the housing. The cover includes a circular passage formed therein, the casing includes an upper peripheral portion rotatably received in the circular passage of the cover.

The cover includes a bottom portion having two concentric peripheral flanges extended therefrom for defining the circular passage between the concentric peripheral flanges, and for rotatably receiving the upper peripheral portion of the casing.

A tube is further provided and engaged between the cover and the base, the cover includes a circular fence extended downwardly therefrom for engaging onto the tube and for securing the tube to the cover.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a perspective view of a light device in accordance with the present invention;

FIG. 2 is a partial cross sectional view taken along lines 2-2 of FIG. 1;

FIG. 3 is an exploded view of the light device;

FIG. 4 is a partial exploded view of the light device;

FIG. 5 is a bottom perspective view of a cover of the light device;

FIG. 6 is a bottom perspective view of an inner casing of the light device;

FIG. 7 is a bottom plan view of the cover of the light device; and

FIG. 8 is a perspective view illustrating the arrangement or application of the light device.

### DETAILED DESCRIPTION OF THE PREFERRED EMBODIMENT

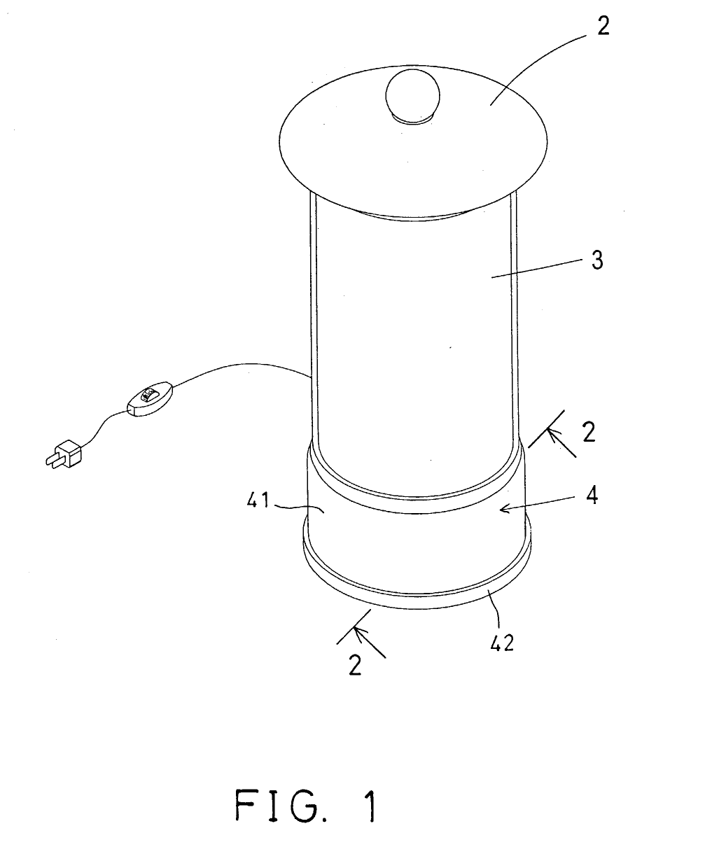

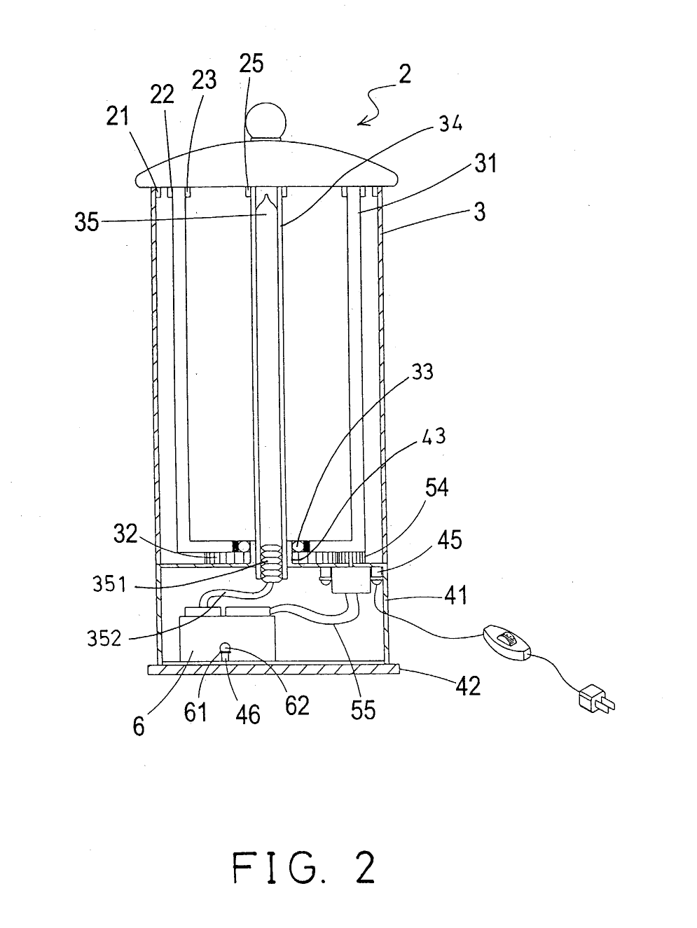

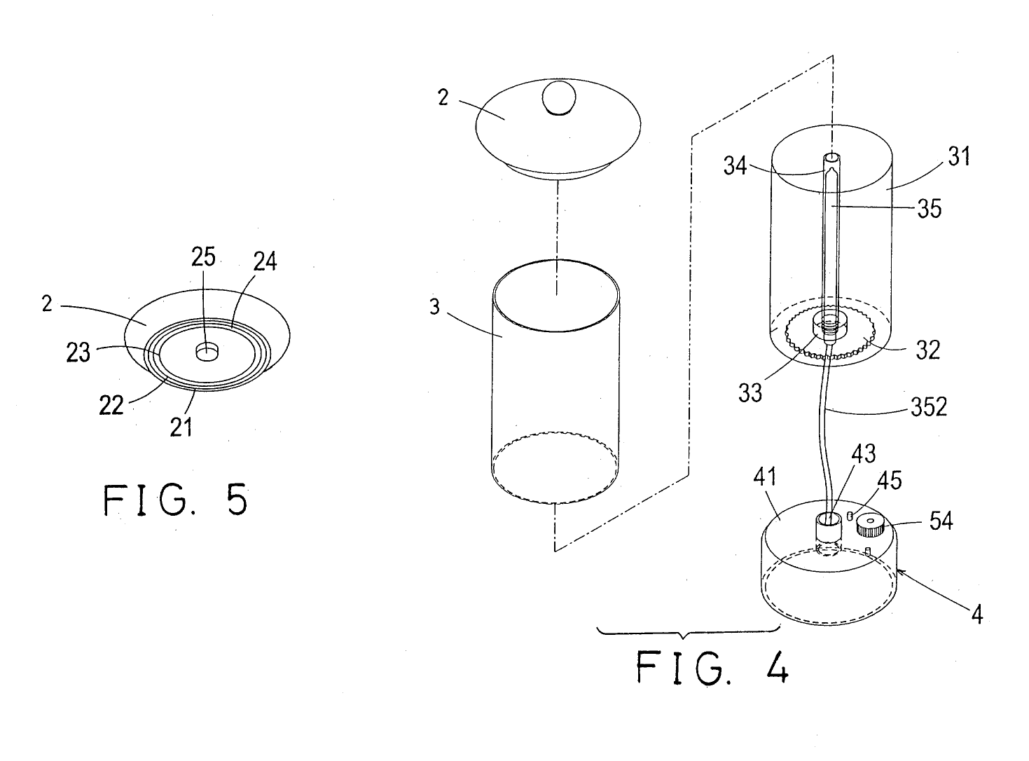

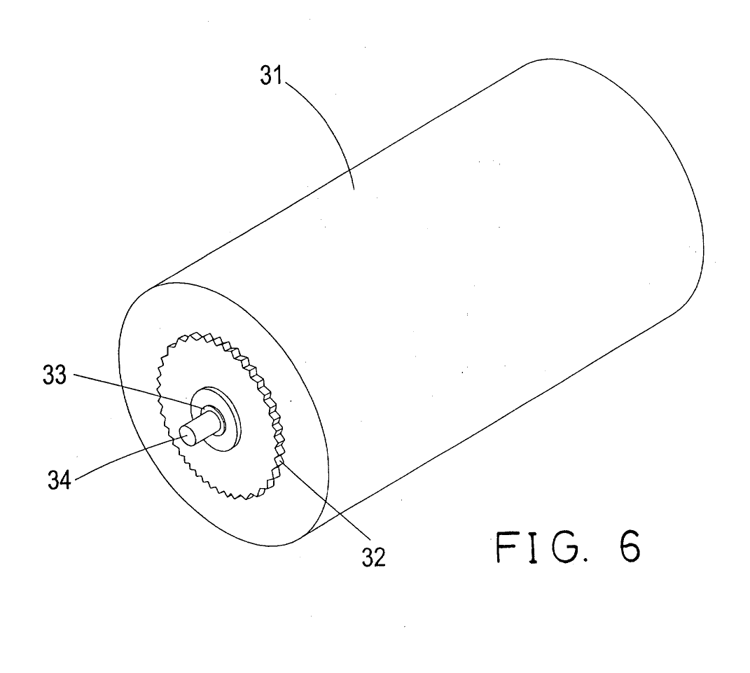

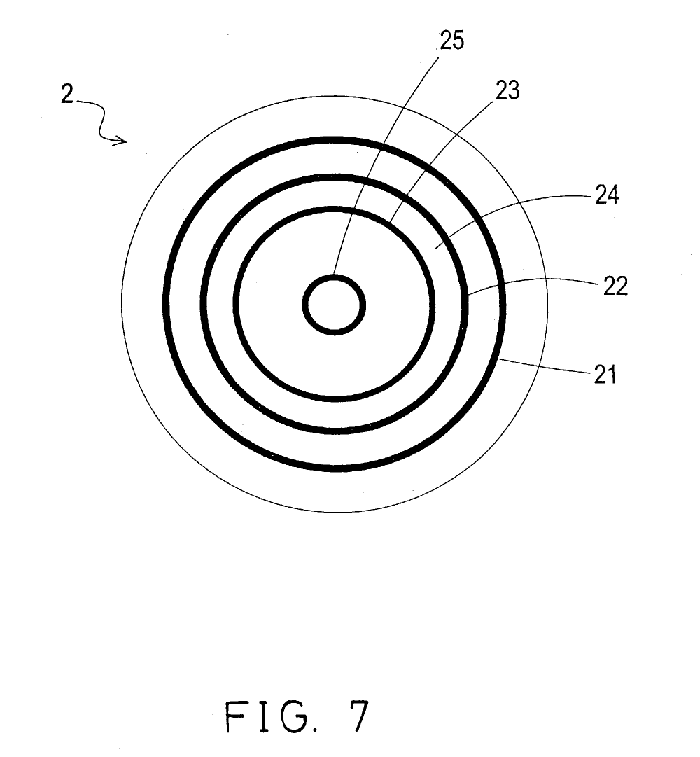

Referring to the drawings, and initially to FIGS. 1-7, a light device in accordance with the present invention comprises a base 4 including a receptacle 41 having a bottom panel 42 attached or detachably secured to the bottom of the receptacle 41, and including a hub 43 provided on the upper portion of the receptacle 41.

A motor 5 includes one or more ears 52 secured to studs 45 of the receptacle 41 with such as fasteners 53, and includes a spindle 51 extended through an orifice 44 of the receptacle 41, and secured to a pinion 54 for rotating or driving the pinion 54.

A power supply or one or more batteries or a transformer 6 includes one or more flaps 61 secured to studs 46 of the receptacle 41 or of the bottom panel 42 with such as fasteners 62, for securing the transformer 6 to the receptacle 41 or to the bottom panel 42. The motor 5 is coupled to the transformer 6 with electric wires 55 so as to be energized by the transformer 6.

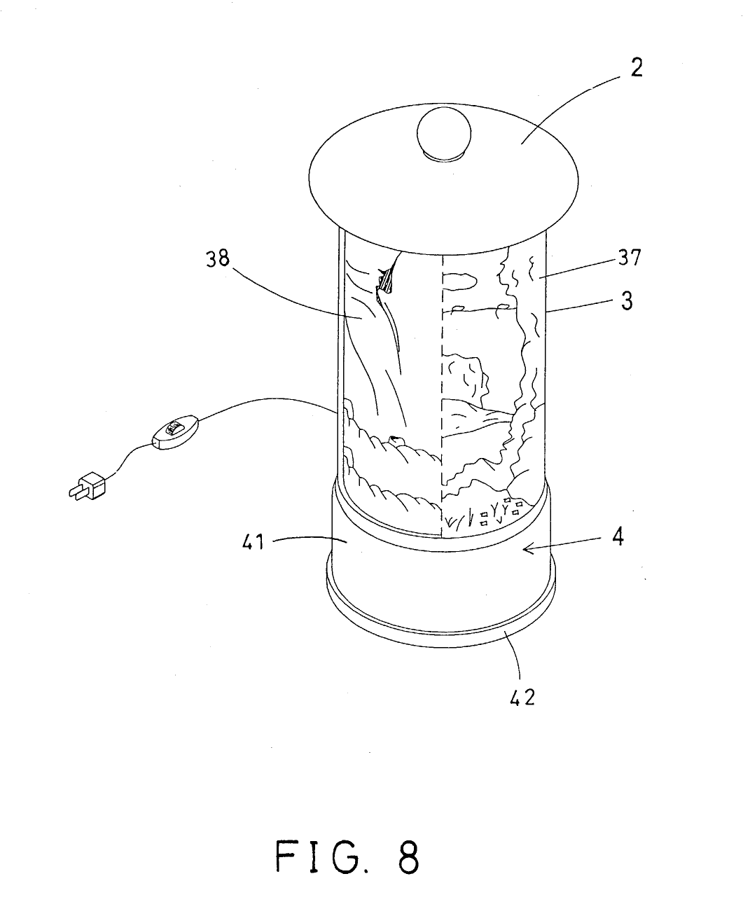

A housing 3 is disposed on top of the receptacle 41, and may be secured to the receptacle 41 with fasteners, adhesive materials, latches, or by welding processes, and preferably includes an outer peripheral portion corresponding to or flushing with or slightly smaller than the outer peripheral portion of the receptacle 41. The housing 3 preferably includes a painting or pattern 37 (FIG. 8) provided thereon.

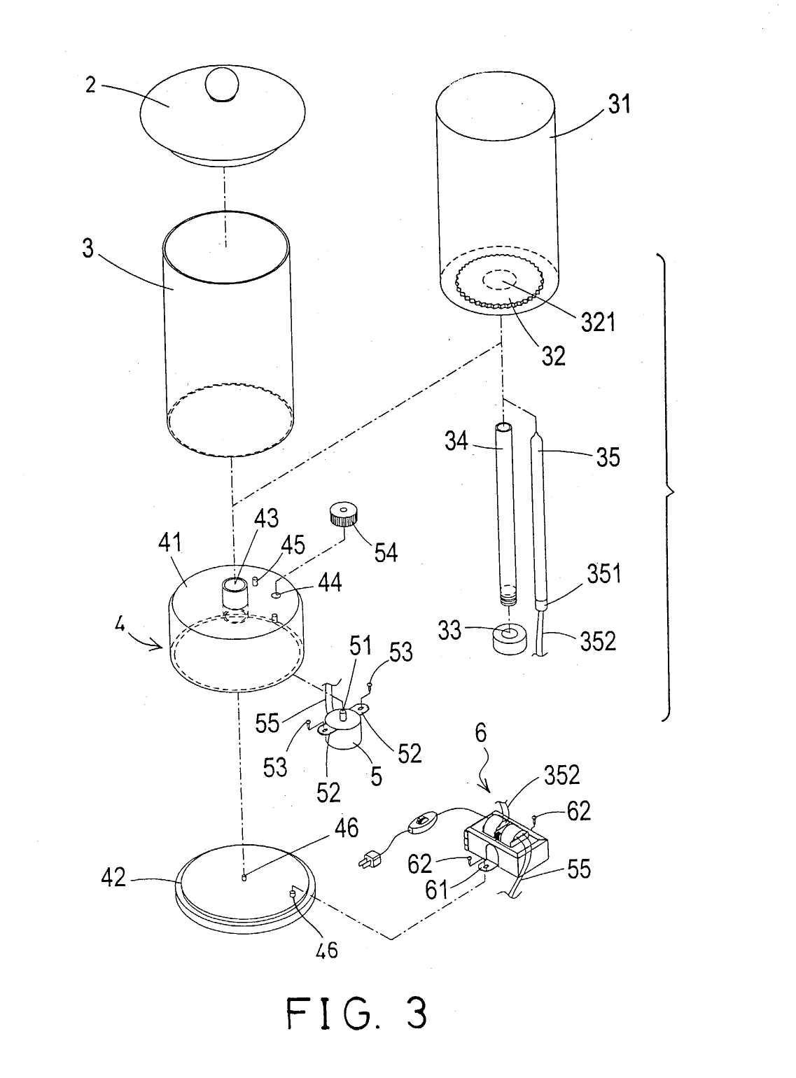

A casing 31 is received in the housing 3 and includes a gear 32 secured to the bottom thereof, and includes an aperture 321 (FIG. 3) formed in the gear 32 for rotatably receiving the hub 43 of the receptacle 41. One or more bearings 33 may be engaged between the casing 31 and the hub 43 for rotatably securing the casing 31 to the receptacle 41.

The gear 32 of the casing 31 is engaged or meshed with the pinion 54, for allowing the casing 31 to be rotated or driven by the motor 5. The casing 31 includes a painting or pattern 38 (FIG. 8) provided thereon for forming or providing a rotatable or movable view or image when the casing 31 is driven by the motor 5 and rotated relative to the receptacle 41.

A tube 34 is received in the casing 31, and is engaged through the hub 43, and will not be rotated in concert with the casing 31, and is preferably made of transparent or semi-transparent materials. A light member 35 is engaged and received in the tube 34, and includes one end 351 coupled to the transformer 6 with electric wires 352, and thus for allowing the light member 35 to be energized by or via the transformer 6.

In operation, as shown in FIG. 8, the pattern 37 formed or provided on the housing 3 is stationary and will not be rotated relative to the receptacle 41. The pattern 38 of the casing 31 may be rotated or moved relative to the pattern 37 of the housing 3 when the casing 31 is rotated relative to the housing 3 and the receptacle 41 by the motor 5. The light member 35 may be energized to light the patterns 37, 38 of the housing 3 and the casing 31.

For example, the pattern 37 of the housing 3 may be formed or applied as a mountain or the like, and the pattern 38 of the casing 31 is formed or painted as water, for forming falls when the patterns 37, 38 of the housing 3 and the casing 31 are moved or rotated relative to each other.

A cover 2 may further be provided and secured on top of the housing 3, and includes a peripheral rib 24 extended downwardly therefrom for engaging with the housing 3, and for securing to the housing 3 with such as a force-fitted engagement, fasteners, latches, or by welding processes. The cover 2 further includes a circular fence 25 extended downwardly therefrom for engaging onto the tube 23, and for securing the tube 34 to the cover 2 and thus to the housing 3.

The cover 2 further includes a circular passage 24 formed therein and defined between two concentric peripheral flanges 22, 23, for rotatably receiving the upper peripheral portion of the casing 31, and thus for stably and rotatably retaining the casing 31 in the housing 3 and between the receptacle 41 and the cover 2.

Accordingly, the light device in accordance with the present invention includes a rotatable or movable casing having a painting or pattern provided thereon for forming or providing a rotatable or movable view or image.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A light device comprising:
a base,
a casing rotatably supported on said base,
a housing disposed on said base and having said casing rotatably received in said housing,
a light member received in said casing, for generating light through said casing and said housing, and
means for rotating said casing relative to said housing.

2. The light device according to claim 1, wherein said housing includes a pattern provided thereon, said casing includes a pattern provided thereon and movable relative to said pattern of said housing when said casing is rotated relative to said housing.

3. The light device according to claim 1, wherein said rotating means includes a motor attached to said base and having a spindle, a pinion attached to said spindle of said motor, and a gear attached to said casing and engaged with said pinion, for allowing said casing to be rotated by said motor via said gear and said pinion.

4. The light device according to claim 3, wherein said base includes a receptacle having a hub provided thereon, said gear includes an aperture formed therein for rotatably receiving said hub of said receptacle.

5. The light device according to claim 3, wherein said rotating means further includes a transformer secured in said base and electrically coupled to said motor.

6. The light device according to claim 1, wherein said base includes a receptacle having a hub provided thereon, said light member is engaged through said hub and received in said casing.

7. The light device according to claim 1 further comprising a cover secured on said housing.

8. The light device according to claim 7, wherein said cover includes a circular passage formed therein, said casing includes an upper peripheral portion rotatably received in said circular passage of said cover.

9. The light device according to claim 8, wherein said cover includes a bottom portion having two concentric peripheral flanges extended therefrom for defining said circular passage between said concentric peripheral flanges, and for rotatably receiving said upper peripheral portion of said casing.

10. The light device according to claim 7 further comprising a tube engaged between said cover and said base, said cover including a circular fence extended downwardly therefrom for engaging onto said tube and for securing said tube to said cover.
